(19) United States
(12) Patent Application Publication
(10) Pub. No.: US 2004/0000409 A1
(43) Pub. Date: Jan. 1, 2004

(54) Method and apparatus for containing wildfires

(76) Inventor: Eugene A. Abbott, Bloomingdale, IL (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(21) Appl. No.: 10/180,841

(22) Filed: Jun. 26, 2002

(51) Int. Cl. A62C 2/00

(52) U.S. Cl. 169/45; 169/48; 169/49; 169/53

(57) ABSTRACT

A method for containing forest fires involves cutting a swath of trees and shrubs surrounding the fire area with use of an aerial saw carried by a helicopter. The swath of cut trees and shrubs is then watered down or covered by flame retardants. The aerial saw is preferably a rotary bladed one suspended horizontally from the helicopter.

### CROSS-REFERENCE TO RELATED PATENT APPLICATIONS

This patent application was disclosed in a Disclosure Document submitted to the Patent Office on May 14, 2002 and was assigned Disclosure Document No. 511,628.

### FIELD OF THE INVENTION

This invention pertains to methods and apparatus for containing wildfires, such as forest fires.

### BACKGROUND OF THE INVENTION

Forest fires have long been costly, tragic and devastating occurrences across the United States and in many other countries around the world. Statistical reporting both currently and historically may be found on the Internet at National Fire News a website of the National Interagency Fire Center, http://www.nific.gov.

In the most part, fire fighting techniques have been manual operations although assisted by aircraft such as helicopters to drop water or chemicals as well as supplies and for movement of personnel.

Methods have been proposed for prevention and fighting forest fires such as those in Nahamias U.S. Pat. Nos. 4,986,363 and 5,070,945, yet the problem persists and no ready solution has been in sight. Cross reference may be made to Herlik U.S. Pat. No. 5,549,259 and the patents cited therein which is repleat with the activities of workers in the art trying to solve the problems associated with fighting forest fires.

The present invention provides such a method and associated apparatus that is capable of containing wild fires. These and other advantages of the invention, as well as additional inventive features, will be apparent from the description of the invention provided herein.

### BRIEF SUMMARY OF THE INVENTION

The invention provides a method performed by an aerial rotating saw device which can be carried by helicopter and involves progressively cutting a wide swath of trees and shrubs surrounding the area of fire to be contained.

My method is performed by providing a substantially horizontal rotating saw device which can be carried by a helicopter that is capable of cutting in a predetermined manner and location, a wide swath of trees and shrubs surrounding the area of fire to be contained.

The swath should be sufficiently outside of the burning area so that the swath is well spaced from the fire area that is to be separated from further forest areas to be protected. Also, the swath itself should be wide enough to prevent crossing over by the fire. It should be sufficiently far from the fire to allow the cutting operation to be performed before the fire reaches the cut swath.

The rotary saw may be independently driven and carried by a framework that may be raised and lowered from the helicopter, although it may be fixed instead. Also, it should be capable of being dropped or disconnected remotely if snagged.

After the swath is cut, the now cut out area is watered down or covered by foam or flame retardants by conventional water or chemical dropping helicopters.

### BRIEF DESCRIPTION OF THE DRAWINGS

FIG. 1 is a perspective view of an illustrative airborne rotary saw performing a swath cutting operation in accordance with the method of the present invention; and

FIG. 2 is an aerial plan view of the method being applied to a forest area for containment of a forest fire.

### DETAILED DESCRIPTION OF THE INVENTION

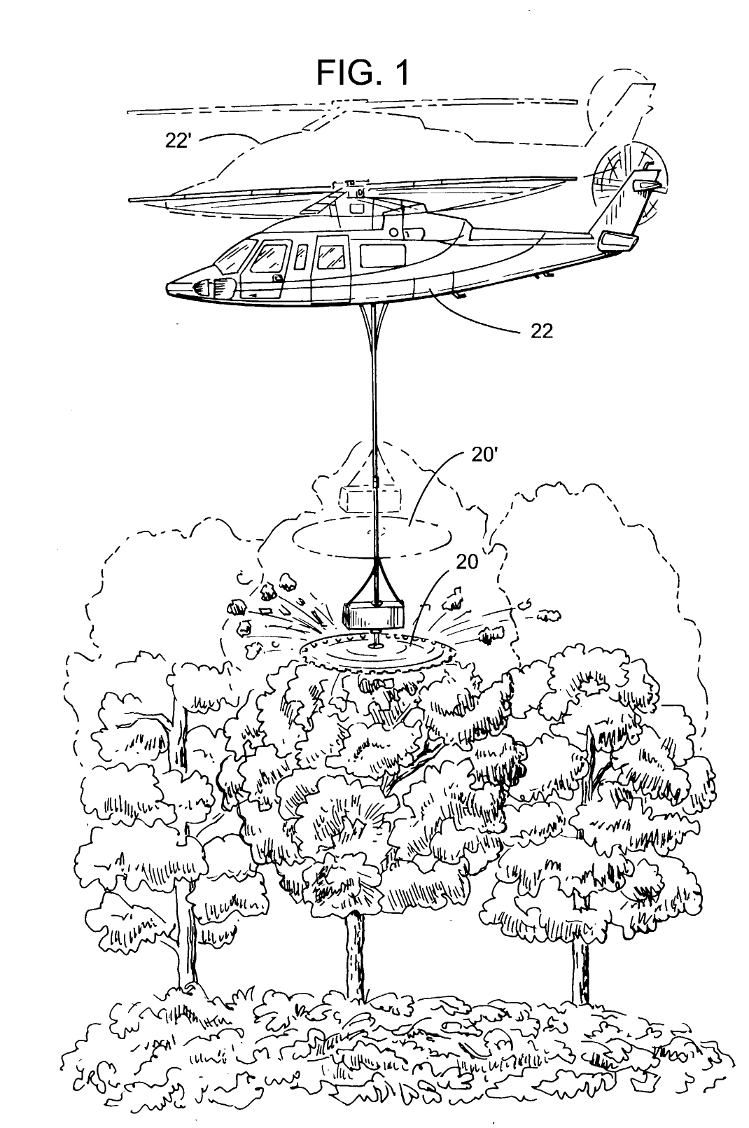

Referring to FIG. 1, there is shown an exemplary rotary saw 20 carried by appropriate suspension lines with a helicopter 22. By way of multiple crops and sweeps (shown in phantom) the helicopter carried saw progressively makes a swath of cut down trees and shrubs that are allowed to pile up in the swath areas.

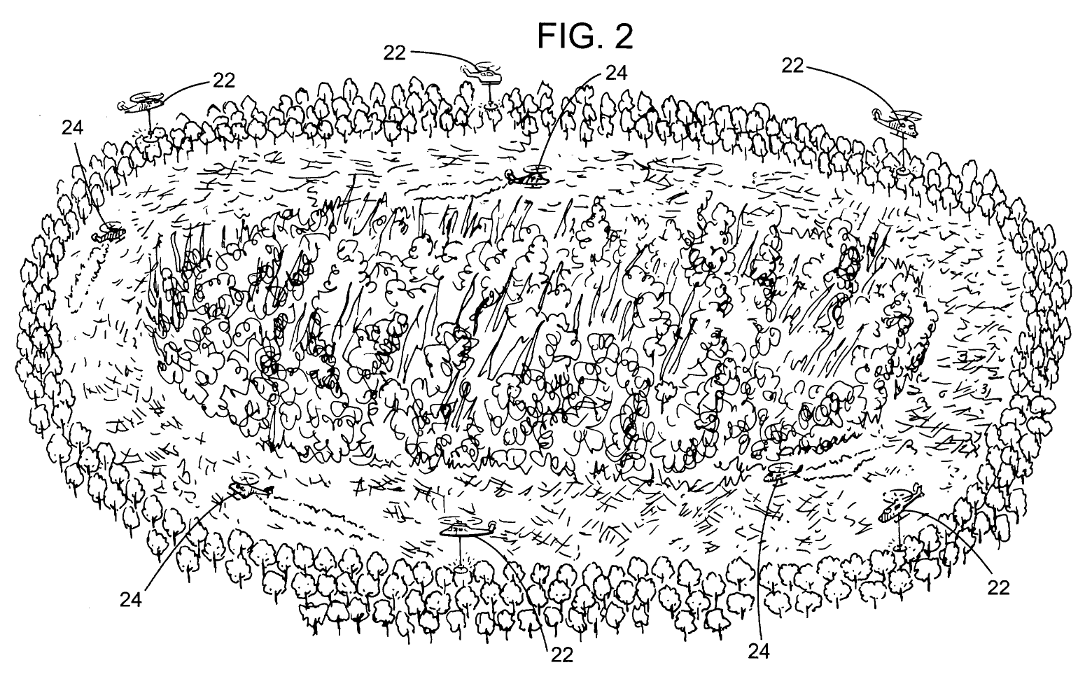

Depending on the extent of the burning forest area and the direction and speed of movement of the fire, the swath cutting operation is commenced at a preselected and predetermined distance to allow a cutting of a wide enough swath and it is made long enough to stop movement across the swath. With the piled-up cut trees and shrubs in the swath area, airborne water and chemical dropping aircraft units 24 can cover the cut swath area such as portrayed with helicopter 24 in FIG. 2.

Aerial cutting saws of various types are known and even used primarily for trimming trees and shrubs adjacent to utility lines. Examples may be seen in U.S. Pat. Nos. 5,961,070, 4,554,781, 2,707,008, 4,815,263 and 4,984,757 and Canadian Patent No. 2,021,812. Generally, the aerial saws have been vertically oriented and designed primarily for trimming operations along side utility lines. In the present performance of my method for containing forest fires, I prefer to have a rotary blade saw suspended in a substantially horizontal attitude when in use so as to enable a progressive cropping and cutting with sweeps by the aerial saw. Large diameter rotary saws are well known and have been used in ground located saw mills for many years. See, for example, Pawlosky U.S. Pat. No. 4,955,273 which relates to the saw tooth inserts as used with large diameter circular saws.

Exemplary chemical foam dispersal helicopter devices are illustrated in Rey U.S. Pat. No. 5,699,862.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A method of containing forestry fires comprising the steps of progressively cutting a swath in trees and shrubs by an airborne saw and cutting in the potential path of the fire burning area, allowing the cut trees and shrubs to pile up in the cut swath and dropping fire quenching liquid on the swath area to further prevent movement of the fire across the swath area.

2. A method as claimed in claim 1 wherein the swath area surrounds the fire burning area.

3. The method as claimed in claim 1 wherein the liquid is water.

4. The method as claimed in claim 3 wherein the water along with other flame retardant chemicals are dropped on the swath area.

5. The method as claimed in claim 1 wherein the airborne saw is a rotary blade saw.

6. The method as claimed in claim 5 wherein the saw is carried aerially in a substantially horizontal attitude.

7. The method as claimed in claim 1 wherein the swath cutting is at a preselected and predetermined distance from the calculated path of movement and location of the fire area.

8. The method as claimed in claim 1 wherein the width of the cut swath is predetermined by height of the forest area adjacent the swath and wind direction and speed of travel of the fire area.

9. The method as claimed in claim 1 wherein the swath is cut in an irregular pattern.

10. Apparatus for containing forest fires involving trees and shrubs and adapted to be carried airborne by a helicopter or the like comprising in combination,
aerial saw means adapted to be suspended from said helicopter,
drive means controllable from the helicopter for operating said saw,
said saw having a rotary blade positioned substantially parallel to the ground when suspended from said helicopter, and
the saw means being operable with said helicopter to progressively cut a swath of the trees and shrubs in the potential path of said forest fire.
